(19) United States
(12) Patent Application Publication
(10) Pub. No.: US 2019/0031423 A1
(43) Pub. Date: Jan. 31, 2019

(54) Desiccant Bag for Electronic Equipment and Method for Producing a Protective Film in Electronic Equipment

(71) Applicant: DEMAC, S.A., Madrid (ES)

(72) Inventors: Jose Luis De La Torre Barreiro, Madrid (ES); Francisco Lorenzo Esteban Azpiroz, Madrid (ES)

(21) Appl. No.: 16/073,253

(22) PCT Filed: Jan. 27, 2016
(86) PCT No.: PCT/ES2016/070043

§ 371 Date: Jul. 26, 2018

(51) Int. Cl. B65D 81/26; F26B 5/04; F26B 9/00; B65B 31/06

(52) U.S. Cl. CPC B65D 81/268; B65B 31/06; F26B 9/00; F26B 5/04

(57) ABSTRACT

Desiccant bag for electronic devices characterized in that it comprises:
A first outer bag, made of plastic, hermetically sealed.
A second porous bag, housed inside the first bag, leaving a gap between the first bag and the second porous bag, in which an absorbent material or drying product (superabsorbent polymer) is housed.
A third porous bag housed inside the second bag, impregnated with an oxygen scavenger material housing the electronic device to be recovered and/or protected
wherein the first two bags are crossed by a transverse pipe which has a connection having a bypass which starting from the connection penetrates inside the third bag. A minimization of the drying time, effectiveness in the process by using mechanical and chemical means and effectiveness that can reach 100% are achieved.

### OBJECT

In one aspect, disclosed is a desiccant bag for electronic devices, whose object is to dry and avoid leaving any trace of moisture in electronic devices (mobile phone, navigator, tablet, etc.) after falling into water or any other liquid.

Also, the desiccant bag can be used as preventive means to make a mobile phone or any other electronic device protected and immune against water or any other liquid. Therefore, the object of the present invention is a procedure for producing a hydrophobic protective film on electronic devices, using the above desiccant bag.

The present invention is characterized by the special design features of the elements that are part of the same, the materials used and the joint provision of such elements, which make it a practical and effective device in the desiccation and protection process of electronic devices.

Therefore, the present invention falls within the field of means used for the desiccation of and moisture removal from electronic devices once these have been in contact with liquids.

### BACKGROUND

In the prior art various devices and means are known to reduce moisture in electronic devices once these have fallen into a liquid medium, although they are only partially effective in achieving the desired purpose, and have aspects that can be improved.

For example, the drying time is quite long, exceeding 12 hours and even 48 hours, not ensuring complete moisture reduction.

The means used are generally reduced to a single way of implementation. In addition, it does not serve as a preventive means for possible future contact with moist media.

One aspect of the disclosure is to disclose a device which enables the desiccation of electronic devices that have been in contact with liquid media, in a reduced time, using two combined forms of moisture removal, wherein successful recovery is on the order of 80 to 90% and even 100% if done within the first hour of having come into contact with the liquid medium.

### DESCRIPTION

In one aspect, the present invention is a desiccant bag for electronic devices comprising:
A first outer bag which is made of plastic material that can be hermetically sealed, e.g. with a double seal.
A second bag housed inside the first bag, and which is made of a porous material, leaving a gap between the first bag and the second porous bag, an absorbent material being housed in said gap. Both bags, the first and second bag have a series of partitions with the function of separating the products arranged between them, in order to form a uniform layer over the entire surface.
A third bag housed inside the second bag, impregnated with an oxygen scavenger material (nitrogen pellets) making it a super-adsorbent material. It is inside this third bag, which is porous, in which the electronic device to recover and/or protect is housed.

The outer plastic bag has at its top a conduit that crosses from one side to the other, presenting an inlet and outlet point in its passage through the outer bag, in addition said conduit has in its midpoint and within the space defined by the first two bags, a bypass that is inserted inside the third bag, so that by passing a stream of a fluid from the inlet to the outlet, it produces a vacuum effect in the bypass so that the wall of the third bag which is impregnated with an oxygen scavenger product is in contact with the electronic device to be recovered and/or protected, enhancing and accelerating the drying process, achieving capillary attraction of the liquid that has got into the electronic equipment.

The absorbent material housed between the first and the second bag, can be super adsorbent polymers.

The super absorbent polymers (or SAP) also called slush powder, are polymers that can absorb and retain extremely large amounts of a liquid relative to their own mass.

The water-absorbing polymers, which are classified as hydrogels when cross-linked, absorb aqueous solutions through hydrogen bonding with water molecules. The ability of a SAP to absorb water is a factor of the ionic concentration of the aqueous solution. In deionized and distilled water, a SAP may absorb 500 times its weight (from 30 to 60 times its own volume) and can become up to 99.9% liquid, but when put into a 0.9% saline solution, the absorbency drops to maybe 50 times its weight. The presence of cations in the solution impedes the ability of the polymer to bond with the water molecule.

The total absorbency and swelling capacity are controlled by the type and degree of cross-linkers used to make the gel. Low-density cross-linked SAPs generally have a higher absorbent capacity and swell to a greater degree. These types of SAPs also have a softer and stickier gel formation. High cross-link density polymers exhibit lower absorbent capacity and swell, but the gel strength is firmer and can maintain particle shape even under moderate pressure.

In a possible embodiment these super adsorbent polymers are sodium polyacrylate, which is a polymer formed by monomers, also known as waterblock.

The ability to absorb large amounts of water is because in its molecular structure there are sodium carboxylate groups pendant from the polymer backbone. These groups, when coming into contact with water emit the sodium cation, leaving negative carboxylate ions free. Negative ions repel, stretching the backbone and causing the increase in volume. For the compound to again become stable and neutral, the ions capture water molecules and the charge is neutralized.

When adding water, the powder grains start absorbing it, and aggregate until forming a kind of crystalline gel. Because this compound has a high molecular mass, rather than dissolving, it gels.

Due to the means described, the following is achieved:
On the one hand, drying time is minimized by completely removing the oxygen contained inside, preventing oxidation, taking less than 12 hours, and even achieving the desired results in 3 hours.
Moreover, effectiveness in the desiccation process by using mechanical means creating the vacuum inside, and on the other hand, by using chemical means removing the oxygen remaining with a chemical reaction.
In addition, a successful recovery that reaches between 80 to 90% and even 100% is achieved if the recovery occurs within the first hour of the accident.

Another aspect of the disclosure is to disclose a procedure for producing a hydrophobic protective film on electronic devices using the above described desiccant bag for electronic devices comprising the steps of:
Housing a centering element inside the third bag,
Placing the electronic device to be protected in the centering element,
Sealing the outlet with a plug,
Arranging a gas cylinder at the inlet so that the gas supplied by the bottle by reacting with the drying or absorbent material introduced into the third bag produces a hydrophobic protective film waterproofing the surface of the device to be protected.

Said bottle containing a composition of a combination of Co2, n-hexane, isopropyl alcohol and acetone bonded to a fluoropolymer.

Unless otherwise indicated, all technical and scientific elements used herein have the meaning commonly understood by one ordinarily skilled in the art to which this invention belongs. In the practice of the present invention, similar or equivalent methods and materials to those described in the specification may be used.

Throughout the description and claims the word “comprises” and its variants are not intended to exclude other technical features, additives, components or steps. For those skilled in the art, other objects, advantages and characteristics of the invention will become apparent partly from the description and partly from the practice of the invention.

### BRIEF DESCRIPTION OF THE DRAWINGS

To complete the description being made and in order to aid a better understanding of the characteristics of the invention according to a preferred practical embodiment thereof, a set of drawings are included as an integral part of said description, which by way of illustration and without limiting the scope of the invention, shows the following.

FIG. 1 shows a schematic representation of the bag sectioned along a vertical plane, wherein the different elements that are part of it and how they relate to each other are illustrated.

FIG. 2 shows a representation of the preceding bag used as a means to create a protective film with hydrophobic properties on the surface of the electronic devices to be protected.

### DETAILED DESCRIPTION

In view of the figures, a preferred embodiment of the invention proposed is described below.

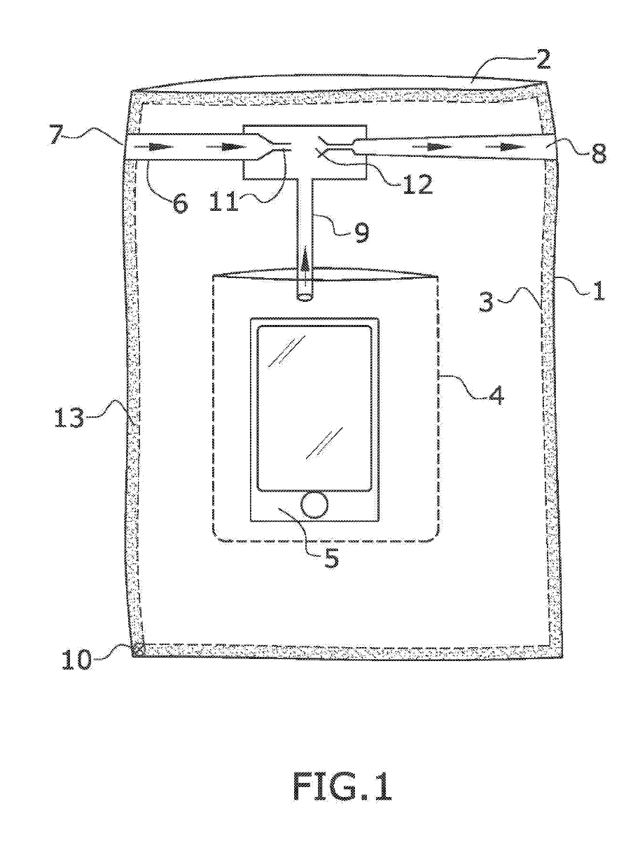

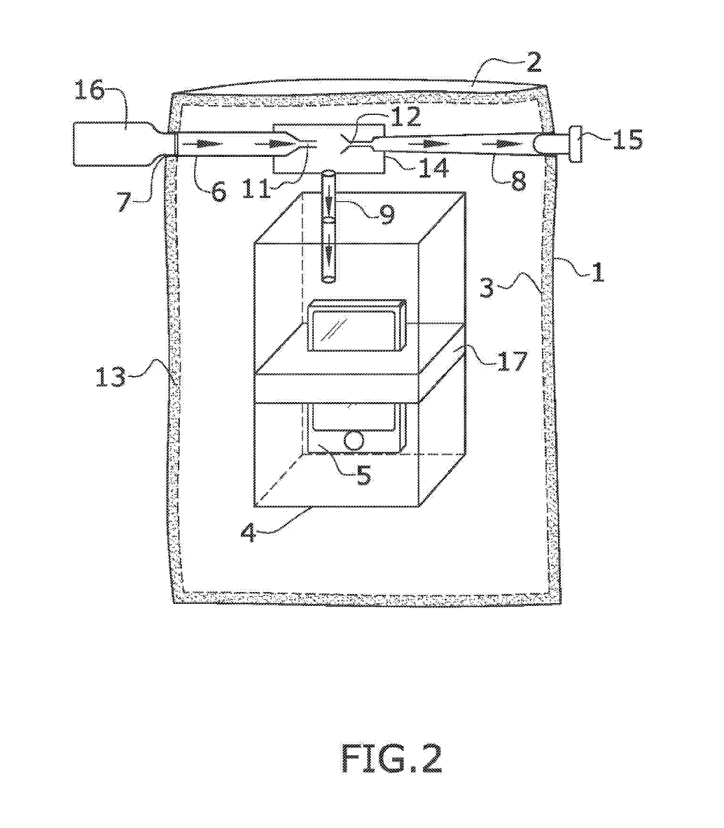

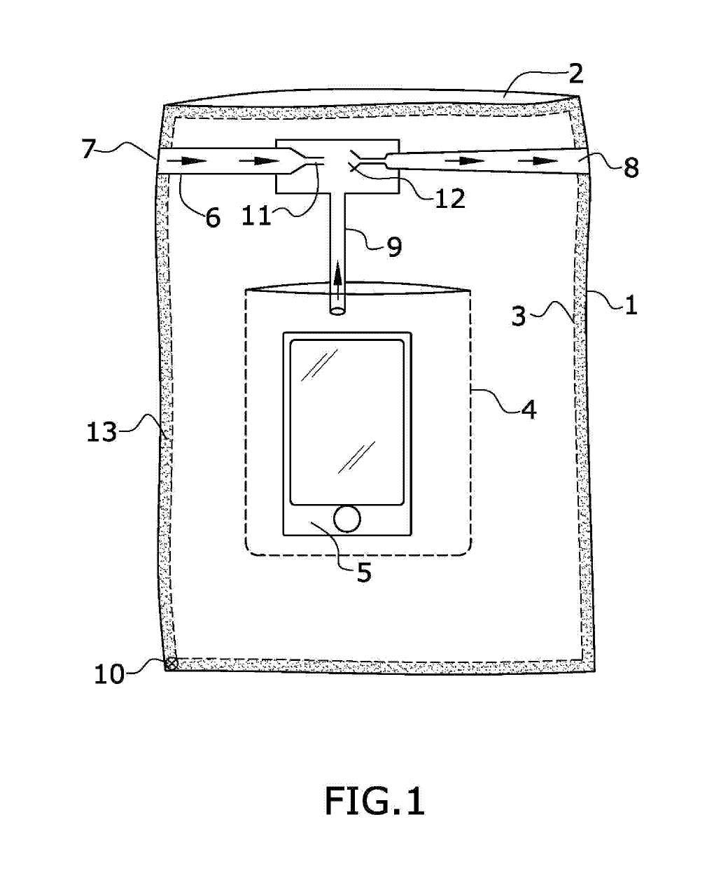

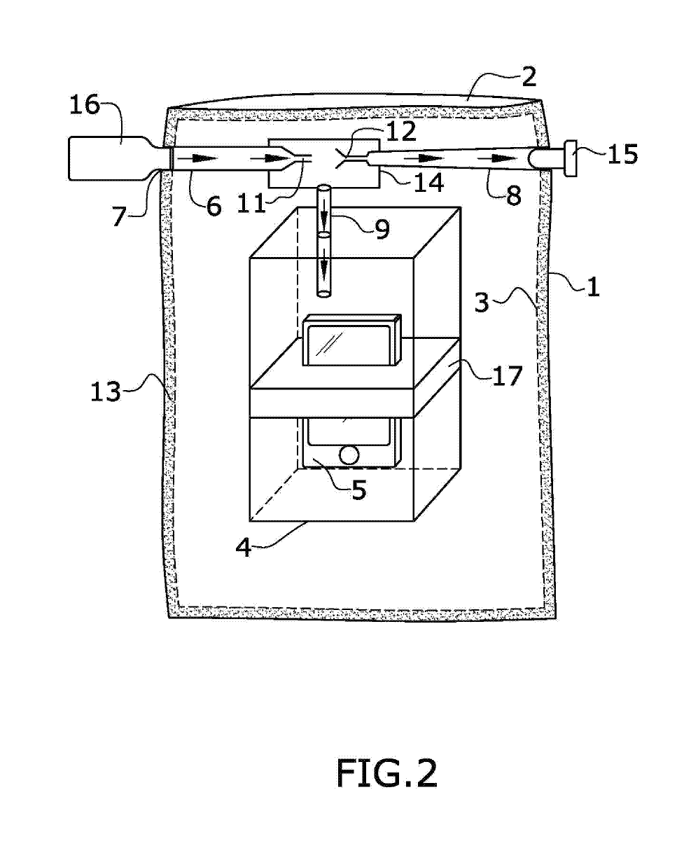

FIG. 1 shows the desiccant bag for electronic devices of the invention comprising:
A first outer bag (1) which is made of plastic material which can be hermetically sealed, for example, with a double seal (2).
A second bag (3), housed inside the first bag (1), and made of porous material, leaving a gap between the first bag and the second porous bag, with an absorbent material or drying product (13) being housed in said gap. Both bags, the first (1) and the second bag (3) have a number of partitions, not shown, with the function of separating the products arranged between them, with the aim of forming a uniform layer over the entire surface.
A third bag (4) housed inside the second bag (3), impregnated with an oxygen scavenger material (nitrogen pellets) making it a super-adsorbent material. It is inside this third bag (4), which is porous, where the electronic device (5) to recover and/or protect is housed.

The first two bags are crossed by a transverse pipe (6), which crosses the interior space defined by both bags, having an inlet (7) and an outlet (8); said pipe has in its interior a connection (14) into which the pipe penetrates from the inlet and emerges towards the outlet (8), and a bypass (9) which, starting from the connection (14) penetrates inside the third bag (4), wherein the electronic device (5) is housed.

The transverse pipe (6) housed at the ends inside the connection (14) comprises check valves (11) and (12), so that by passing a fluid, preferably air through the inlet (7) towards the outlet (8), in its path it produces a vacuum or a depression inside the third bag (4) causing all the air contained inside to go out, producing contact of the porous wall of this third bag with the electronic device, thus ensuring that the terminal is cleaned and that all residues come out through that hole and that thanks to the heat effect generated and the vacuum produced, it is possible to recover the electronic device which came into contact with a liquid.

Thanks to the presence of check valves (11) and (12) in the connection (14) a liquid, for example water can be used as depression-producing fluid in the bypass (9).

In the space between the outer bag and the inner bag, an absorbent or drying material is arranged, preferably polymers which can absorb and retain extremely large amounts of a liquid relative to their own mass, hence they are known as super absorbent polymers.

Both bags, the first outer bag (1) and the second bag (2) have on their facing sides with a series of partitions that allow uniform distribution of the absorbent and drying product across the entire surface. Furthermore, in the area of the space between both bags, there is an air extraction valve (10).

As also noted above, the drying bag serves as means for preventing disablement of an electronic device in case of direct contact with moisture. In this case, the inner bag can be removed depending on the size of the object introduced or otherwise a centering element (17) is introduced into the third bag (4), as shown in FIG. 3, in which the electronic device to protect is housed so that the walls of this third bag do not come into contact with the electronic device, and in addition the outlet (8) is covered with a plug or stopper (15), a gas is introduced through the inlet (7) which for example may come from a bottle (16), which can be fixed in the inlet (7) by screwing.

Said bottle (16) contains a composition of a combination of Co2, n-hexane, isopropyl alcohol and acetone bonded to a fluoropolymer. Thanks to this gas mixed with the powder introduced into the bag, a protective film with hydrophobic properties designed to waterproof the surface and prevent the action of water is formed inside the device.

Thanks to this gas mixed with powder introduced into the bag, i.e., the drying or adsorbent material (superabsorbent polymers) is formed inside the device a protective film with hydrophobic properties designed to waterproof the surface and prevent the action of water is formed inside the device.

In some devices, the bypass (9) is inserted through a hole in the device to be protected to ensure the entry of the gasified product, but this is not too important as the product is based on a nanoscale size structure that maintains a microscopic film of air from the nanostructure of super hydrophobic powder on surfaces where the product is sprayed, producing a change in the solid-water basic interface preventing the liquid from interacting with the surface.

Once the preventive treatment has been performed it is important to avoid in the next 48 hours an accident or getting the treated object wet.

Also, it is very important to thoroughly clean the object before being treated and if possible remove the battery and any accessories or data card or Sim card in the case of a phone.

This operation should be done for both treatments, i.e., treatment as a desiccant and as prevention.

Having sufficiently described the nature of the present invention, as well as how to implement it, it should be noted that, within its essence, it may be implemented in other embodiments that differ in detail from that indicated by way of example, and which are also acquire the protection, provided that its fundamental principle is not altered, changed or modified.

1. Desiccant bag for electronic devices, comprising:
A first outer bag, which is made of plastic material capable of being hermetically sealed.
A second bag, housed inside the first bag, and made of porous material, leaving a gap between the first bag and the second porous bag, wherein an absorbent material or drying product resides in said gap a.
A third porous bag housed inside the second bag, wherein said third porous bag is impregnated with an oxygen scavenger material, said third porous bag forming a chamber wherein the electronic device to be recovered and/or protected is housed.
wherein the first and second bags are crossed by a transverse pipe, crossing an interior space defined by both bags, said transverse pipe having an inlet and an outlet and in its interior, a connection into which the conduit penetrates from the inlet and emerges towards the outlet, and a bypass which starting from the connection penetrates inside the third bag, in which the electronic device is housed.

2. Desiccant bag for electronic devices, according to claim 1, wherein the transverse pipe at the ends housed inside the connection has check valves, so that by passing fluid through the inlet towards the outlet, in its path it produces a vacuum or a depression inside the third bag.

3. Desiccant bag for electronic devices, according to claim 1, wherein the first and the second bag have a number of partitions on their facing sides in order to form a uniform layer over the entire surface.

4. Desiccant bag for electronic devices according to claim 1, wherein the material impregnating the pores of the third bag are Nitrogen pellets.

5. Desiccant bag for electronic devices according to claim 1, wherein the absorbent material or drying product housed in the space comprised between the first and second bags are superabsorbent polymers.

6. A procedure for producing a hydrophobic protective film on electronic devices using the desiccant bag for electronic devices according to claim 1, including the steps of:
Housing a centering element inside the third bag,
Placing the electronic device to protect in the centering element,
Sealing the outlet by a plug,
Arranging a gas cylinder in the inlet so that the gas supplied by the bottle, by reacting with the drying or absorbent material introduced in the third bag, produces a hydrophobic protective film waterproofing the surface of the device to be protected.

7. Procedure for producing a hydrophobic protective film on electronic devices according to claim 6, wherein the gas contained in the bottle includes a combination of Co2, n-hexane, isopropyl alcohol and acetone bonded to a fluoropolymer.
